(19) United States
(12) Patent Application Publication
(10) Pub. No.: US 2013/0185134 A1
(43) Pub. Date: Jul. 18, 2013

(54) Service Systems and Methods

(71) Applicant: CHIDOPI CO., LTD., Taipei City (TW)

(72) Inventor: Jason Hung, Taoyuan County (TW)

(73) Assignee: CHIDOPI CO., LTD., Taipei City (TW)

(21) Appl. No.: 13/739,064

(22) Filed: Jan. 11, 2013

(30) Foreign Application Priority Data
Jan. 13, 2012 (TW) 101101544

(51) Int. Cl. G06Q 30/02

(52) U.S. Cl. CPC G06Q 30/0231
USPC 705/14.31; 705/14.49

(57) ABSTRACT

Service systems and methods to be used in an application (App) download use environment are provided. After at least one user selects an icon related to an application in a browser picture, an advertisement link related to the application is presented on a wall of a personal webpage on a social website corresponding to the at least one user. After the advertisement link is selected, the browser picture having the application is returned, and/or, a number of selection times of the icon in the browser picture for each user is recorded, and the number of selection times of the icon for each user is transformed into reward points. The user can exchange the accumulated reward points for redeem applications provided by an application developer.

### BACKGROUND OF THE INVENTION

1. Field of the Invention

The present invention relates generally to service systems and methods, and more particularly, to service systems and methods to be used in an application (App) download use environment. After an icon related to an application in a browser picture is selected, an advertisement link related to the application is presented on a wall of a personal webpage on a social website corresponding to the user. A number of selection times of the icon in the browser picture for each user is recorded, and the number of selection times of the icon for each user is transformed into reward points. The user can exchange the accumulated reward points for redeem applications provided by an application developer. In the method that the application developer allows users to exchange reward points for applications, the user browse popularity of the application in the browser picture can be quantized into reward points, and provided to the application developer for subsequent use.

2. Description of the Related Art

In a conventional network trading/service model, during the purchase of physical commodities and/or virtual commodities (such as applications), since the providers, such as application developers cannot know the network browse popularity data, they cannot timely adjust the functions of applications, such that the situation that the applications are not conforming to the market requirement may be occurred. Additionally, since the user browse popularity data is not known, when some applications are freely promoted, the applications which are most suitable for users may not be provided to the users with a free promotion, resulting in a bottleneck of the free promotion.

Further, when a purchaser thinks the price of a commodity is too high and/or cannot obtain free use of the commodity, the action that the purchaser only can do is not to purchase the commodity, and that is no way to provide his own opinions and/or a reasonable price which is expected by the purchaser of the commodity to the commodity seller. Also, since the commodity seller cannot receive responses from the purchaser, no two-way communication is existed between the commodity seller and the purchaser, thus facing a bottleneck during commodity selling.

Additionally, for network purchasers, the discounted price of a physical commodity and/or a virtual commodity (such as an application) is determined by the commodity seller, for example, the commodities sold by the Groupon website. In other words, in general, no matter the number of purchaser, the purchasers cannot actively ask the seller for a required discount, and the price is unilaterally determined by the commodity seller.

Further, during a general network browsing, since the seller cannot obtain the browse popularity data, the seller cannot supply a commodity to the consumer with a free promotion and/or a price reduction promotion, according to the use situation of the consumer, such as pressing a [good] button, such that the seller cannot definitely control the newest use trend of applications. Additionally, since the user cannot exchange his webpage browse records, such as pressing a [good] button for freely downloading applications, the popularity of a website having applications may not be raised. Also, a user cannot link the webpage having the applications to a personal webpage on a social website, such that the user is uninterested in the promoted applications.

Consequently, for current network service models, it is expected that a network service platform to be used in an application download use environment can be provided, wherein after a user selects an icon related to an application in a browser picture, an advertisement link related to the application is presented on a wall of a personal webpage on a social website (for example, Facebook, Weibo, QQ, Twitter, and others) corresponding to the user. After the advertisement link is selected, the browser picture having the application is returned, and/or, a number of selection times of the icon in the browser picture for each user is recorded, and the number of selection times of the icon for each user is transformed into reward points. The user can exchange the accumulated reward points for redeem applications provided by an application developer. In the method that the application developer allows users to exchange reward points for applications, the user browse popularity of the application in the browser picture can be quantized into reward points, and provided to the application developer for subsequent development reference. Here, the application developer can set an acquiring manner for the application in the browser picture, wherein the acquiring manner may be a manner where the application is exchanged by using the reward points quantized from the number of selection times of the icon, and/or a free acquiring manner and/or a price reduction promotion manner.

### BRIEF SUMMARY OF THE INVENTION

The objective of the present invention is to provide a service system and method to be used in an application download use environment, wherein after at least one user selects an icon related to an application in a browser picture, an advertisement link related to the application is presented on a wall of a personal webpage on a social website (for example, Facebook, Weibo, QQ, Twitter, and others) corresponding to the at least one user. After the advertisement link is selected, the browser picture having the application is returned.

Another objective of the present invention is to provide a service system and method to be used in an application download use environment, wherein after at least one user selects an icon related to an application in a browser picture, a number of selection times of the icon in the browser picture for each user is recorded, and the number of selection times of the icon for each user is transformed into reward points. The user can exchange the accumulated reward points for redeem applications provided by an application developer. In the method that the application developer allows users to exchange reward points for applications, the user browse popularity of the application in the browser picture can be quantized into reward points, and provided to the application developer for subsequent development reference.

Another objective of the present invention is to provide a service system and method to be used in an application download use environment, wherein the application developer can set an acquiring manner for the application in the browser picture, wherein the acquiring manner may be a manner where the application is exchanged by using the reward points quantized from the number of selection times of the icon, and/or a free acquiring manner and/or a price reduction promotion manner.

According to above objectives, the present invention provides a service system comprising a service processing module and an application database.

The service processing module receives a use message of a browse picture corresponding to at least one user on a network user side. Here, the use message can comprise an icon selection message and/or an advertisement link message, and/or an exchange message.

Here, the icon selection message is a message transmitted by a browse picture after at least one user selects an icon related to an application in the browse picture. The service processing module receives and processes the icon selection message, and presents an advertisement link related to the application on a wall of a personal webpage on a social website (for example, Facebook, Weibo, QQ, Twitter, and others) corresponding to the at least one user. Additionally, the service processing module operates in coordination with the application database to record a number of selection times of the icon in the browser picture for each user, and transforms the number of selection times of the icon for each user into reward points, and stores the number of selection times of the icon and the reward points for each user in the application database.

Additionally, the advertisement link message is a message that transmitted after an advertisement link presented on a wall of a personal webpage on a social website (for example, Facebook, Weibo, QQ, Twitter, and others) corresponding to the at least one user is selected. On a wall of a personal webpage on a social website (for example, Facebook, Weibo, QQ, Twitter, and others) corresponding to the at least one user, after the advertisement link related to the application is selected, the advertisement link message is transmitted to the service processing module. After the advertisement link message is received, the service processing module returns the browse picture of the at least one user to the browser picture having the application.

The exchange message is a message transmitted by the browser picture when the respective user exchanges the redeem applications provided by the application developer. Here, the application database has recorded the reward points transformed from the number of selection times of the icon for each user. After the exchange message is received, the service processing module operates in coordination with the application database to let the user to exchange the redeem applications provided by the application developer according to the reward points transformed from the number of selection times of the icon for the user. The service processing module provides the exchanged applications to the user.

The application database records the reward points transformed from the number of selection times of the icon for respective users, and/or the applications provided by the application developer. Here, the applications can be obtained by exchanging the reward points transformed from the number of selection times of the icon, and/or with a free acquiring manner and/or a price reduction promotion manner.

In the procedure of a service method using the service system of the present invention, first, after at least one user selects an icon related to an application in a browser picture, the service processing module receives an icon selection message, and presents an advertisement link related to the application on a wall of a personal webpage on a social website (for example, Facebook, Weibo, QQ, Twitter, and others) corresponding to the at least one user.

Then, the service processing module processes the icon selection message, and after the advertisement link is selected, the browser picture having the application is returned, and/or, a number of selection times of the icon in the browser picture for each user is recorded, and the number of selection times of the icon for each user is transformed into reward points. The user can exchange the accumulated reward points for redeem applications provided by an application developer. In the method that the application developer allows users to exchange reward points for applications, the user browse popularity of the application in the browser picture can be quantized into reward points, and provided to the application developer for subsequent development reference.

Here, the application developer can set an acquiring manner for the application in the browser picture, wherein the acquiring manner may be a manner where the application is exchanged by using the reward points quantized from the number of selection times of the icon, and/or a free acquiring manner and/or a price reduction promotion manner.

Service methods may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a system schematic diagram illustrating the system architecture and operation situations of the service system of the present invention;

FIG. 2 is a flowchart of procedure steps of a service method performed by the service system of the present invention;

FIG. 3 is a flowchart of a detailed procedure of steps for handling the received icon selection message in FIG. 2;

FIG. 4 is a flowchart of another detailed procedure of steps for handling the received icon selection message in FIG. 2;

FIG. 5 is a system schematic diagram illustrating an embodiment and operation situations of the service system of the present invention;

FIG. 6 is a flowchart of procedure steps of a service method performed by the embodiment of the service system of the present invention in the FIG. 5;

FIG. 7 is a system schematic diagram illustrating another embodiment and operation situations of the service system of the present invention; and

FIG. 8 is a flowchart of procedure steps of a service method performed by the embodiment of the service system of the present invention in the FIG. 7.

### DETAILED DESCRIPTION OF THE INVENTION

Service systems and methods are provided.

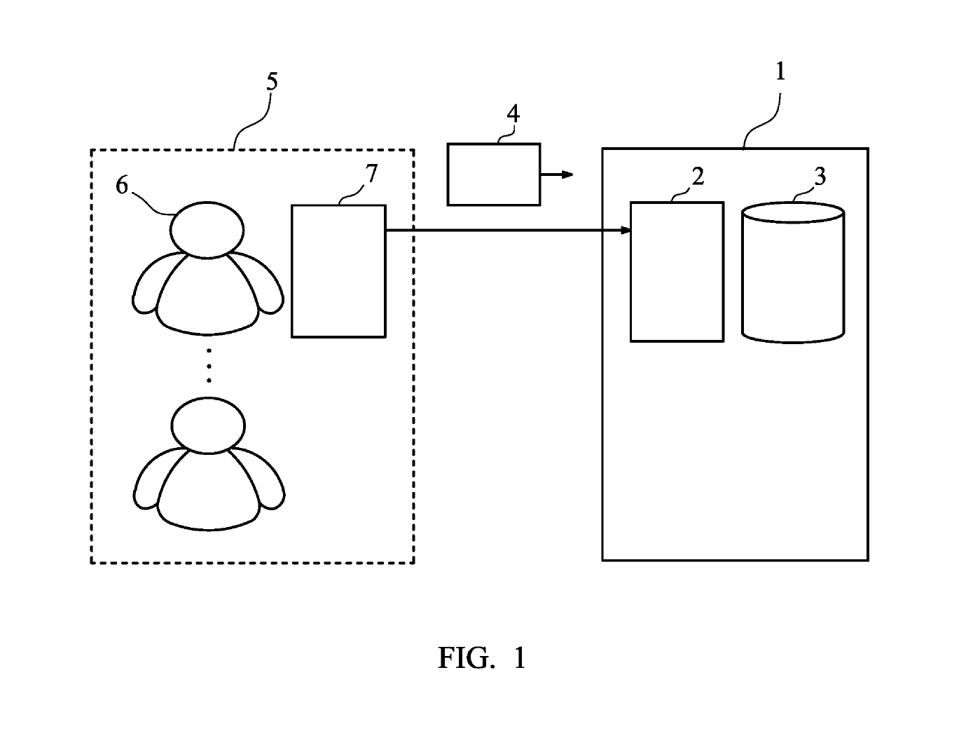

FIG. 1 is a system schematic diagram illustrating the system architecture and operation situations of the service system of the present invention. As shown in FIG. 1, the service system 1 comprises a service processing module 2, and an application database 3.

The service processing module 2 receives a use message 4 of a browse picture 7 corresponding to at least one user 6 on a network user side 5. Here, the use message 4 can comprise an icon selection message (not shown) and/or an advertisement link message (not shown), and/or an exchange message (not shown).

Here, the icon selection message is a message transmitted by the browse picture 7 after at least one user 6 selects an icon (not shown) related to an application (not shown) in the browse picture 7. The service processing module 2 receives and processes the icon selection message, and presents an advertisement link related to the application on a wall (not shown) of a personal webpage on a social website (for example, Facebook, Weibo, QQ, Twitter, and others) corresponding to the at least one user 6. Additionally, after receiving the icon selection message, the service processing module 2 operates in coordination with the application database 3 to record a number of selection times of the icon in the browser picture 7 for each user, and transforms the number of selection times (not shown) of the icon for each user into reward points (not shown), and stores the number of selection times of the icon and the reward points for each user in the application database 3.

Additionally, the advertisement link message is a message that transmitted after an advertisement link (not shown) presented on a wall (not shown) of a personal webpage on a social website (for example, Facebook, Weibo, QQ, Twitter, and others) corresponding to the at least one user 6 is selected. On a wall of a personal webpage on a social website (for example, Facebook, Weibo, QQ, Twitter, and others) corresponding to the at least one user 6, after the advertisement link related to the application is selected, the advertisement link message is transmitted to the service processing module 2. After the advertisement link message is received, the service processing module 2 returns the browse picture 7 of the at least one user 6 to the browser picture (not shown) having the application.

The exchange message is a message transmitted by the browser picture 7 when the respective user 6 exchanges the redeem applications (not shown) provided by the application developer (not shown). Here, the application database 3 has recorded the reward points transformed from the number of selection times of the icon for each user 6. After the exchange message is received, the service processing module 2 operates in coordination with the application database 3 to let the user 6 to exchange the redeem applications provided by the application developer according to the reward points transformed from the number of selection times of the icon for the user 6. The service processing module 2 provides the exchanged applications to the user 6.

The application database 3 records the reward points transformed from the number of selection times of the icon for respective users 6, and/or the applications provided by the application developer. Here, the applications can be obtained by exchanging the reward points transformed from the number of selection times of the icon, and/or with a free acquiring manner and/or a price reduction promotion manner.

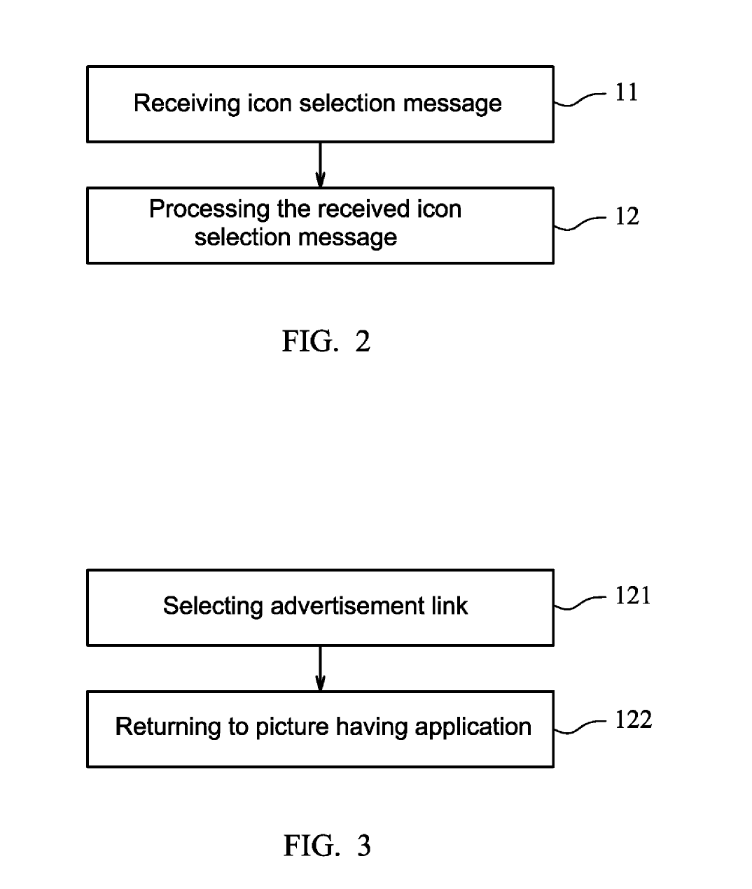

FIG. 2 is a flowchart of procedure steps of a service method performed by the service system of the present invention. As shown in FIG. 2, first, in step 11, after at least one user 6 selects an icon related to an application in a browser picture 7, an icon selection message is transmitted, and the service processing module 2 receives the icon selection message, and presents an advertisement link related to the application on a wall of a personal webpage on a social website (for example, Facebook, Weibo, QQ, Twitter, and others) corresponding to the at least one user 6. The procedure goes to step S12.

In step S12, the service processing module 2 processes the icon selection message, that is, after the advertisement link is selected, the browser picture having the application is returned, and/or, a number of selection times of the icon in the browser picture 7 for each user 6 is recorded, and the number of selection times of the icon for each user 6 is transformed into reward points. The user 6 can exchange the accumulated reward points for redeem applications provided by an application developer. In the method that the application developer allows users to exchange reward points for applications, the user browse popularity of the application in the browser picture can be quantized into reward points, and provided to the application developer for subsequent development reference.

FIG. 3 is a flowchart of a detailed procedure of steps for handling the received icon selection message in FIG. 2. As shown in FIG. 3, in step 121, on a wall of a personal webpage on a social website (for example, Facebook, Weibo, QQ, Twitter, and others) corresponding to the at least one user 6, after the advertisement link related to the application is selected, the advertisement link message is transmitted to the service processing module 2. The procedure goes to step 122.

In step 122, after the advertisement link message is received, the service processing module 2 returns the browse picture 7 of the at least one user 6 to the browser picture (not shown) having the application.

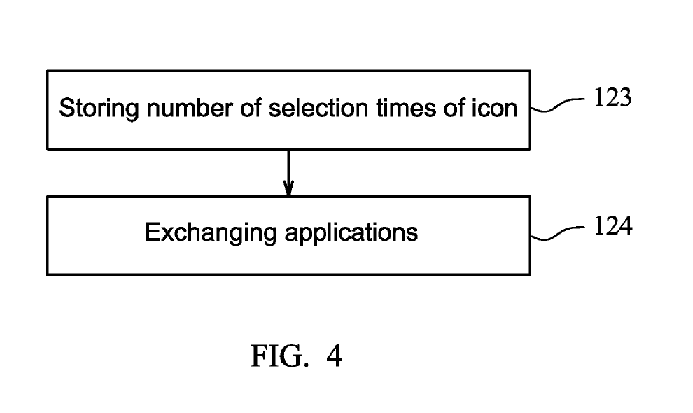

FIG. 4 is a flowchart of another detailed procedure of steps for handling the received icon selection message in FIG. 2. As shown in FIG. 4, in step 123, after receiving the icon selection message, the service processing module 2 operates in coordination with the application database 3 to record a number of selection times of the icon in the browser picture 7 for each user, and transforms the number of selection times (not shown) of the icon for each user into reward points, and stores the number of selection times of the icon and the reward points for each user in the application database 3. The procedure goes to step 124.

In step 124, the user can exchange the redeem applications provided by the application developer. After the service processing module 2 receives the exchange message from the user 6, the service processing module 2 operates in coordination with the application database 3 to let the user 6 to exchange the redeem applications provided by the application developer according to the reward points transformed from the number of selection times of the icon for the user 6. The service processing module 2 provides the exchanged applications to the user 6.

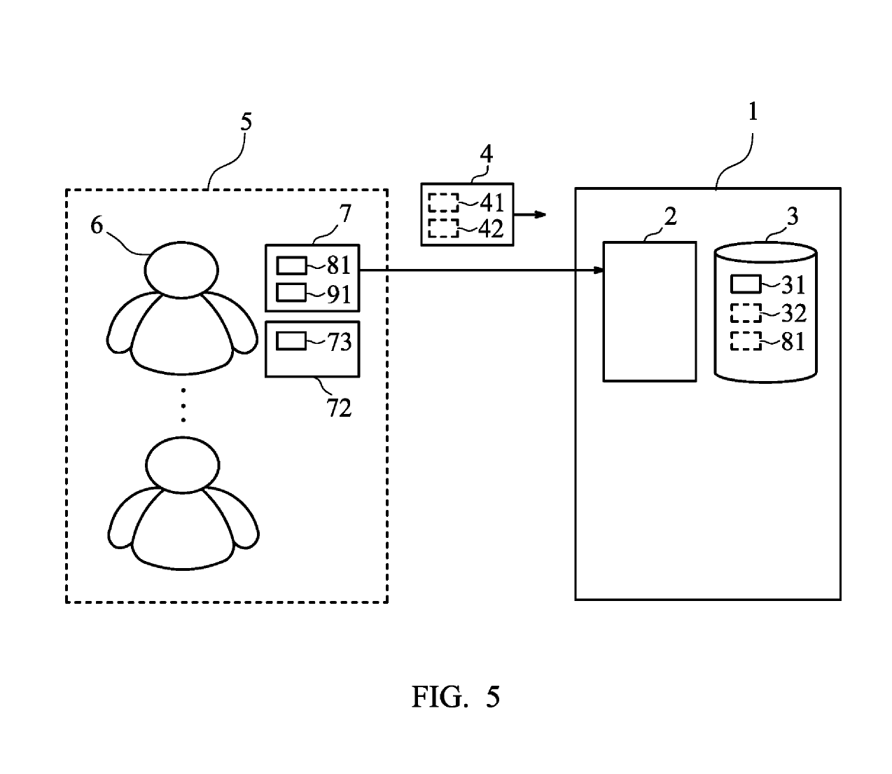

FIG. 5 is a system schematic diagram illustrating an embodiment and operation situations of the service system of the present invention. As shown in FIG. 5, the service system 1 comprises a service processing module 2, and an application database 3. Here, the personal webpage on a social website corresponding to the user 6 is Facebook, for example.

The service processing module 2 receives a use message 4 of a browse picture 71 corresponding to at least one user 6 on a network user side 5. Here, the use message 4 can comprise an icon selection message 41 and/or an advertisement link message 42.

Here, the icon selection message 41 is a message transmitted by the browse picture 71 after at least one user 6 selects an icon 91 related to an application 81 in the browse picture 71. The service processing module 2 receives and processes the icon selection message 41, and presents an advertisement link 73 related to the application 81 on a wall 72 on Facebook corresponding to the at least one user 6. Additionally, after receiving the icon selection message 41, the service processing module 2 operates in coordination with the application database 3 to record a number of selection times of the icon in the browser picture 71 for each user 6, and transforms the number of selection times (not shown) of the icon for each user into reward points 31, and stores the number of selection times of the icon and the reward points 31 for each user 6 in the application database 3.

Additionally, the advertisement link message 42 is a message that transmitted after an advertisement link 73 related to the application 81 and presented on a wall 72 on Facebook corresponding to the at least one user 6 is selected. On a wall 72 on Facebook corresponding to the at least one user 6, after the advertisement link 73 related to the application is selected, the advertisement link message 42 is transmitted to the service processing module 2. After the advertisement link message 42 is received, the service processing module 2 returns the browse picture of the at least one user 6 to the browser picture 72 having the application 81.

The application database 3 records the reward points 31 transformed from the number of selection times of the icon for respective users 6, and/or the applications 81 and applications 32 provided by the application developer (not shown). Here, the applications 32 can be obtained by exchanging the reward points transformed from the number of selection times of the icon, and/or with a free acquiring manner and/or a price reduction promotion manner.

In the embodiment, although the personal webpage on the social website corresponding to the user 6 is Facebook, however, for other personal webpage on the social websites, such as Weibo, QQ, Twitter, and others, the implementation situations and principle are similar to that of the present embodiments, and are omitted.

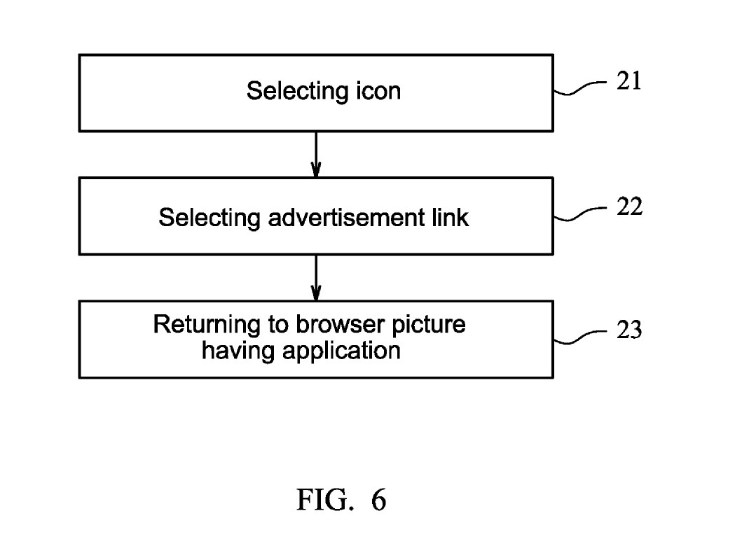

FIG. 6 is a flowchart of procedure steps of a service method performed by the embodiment of the service system of the present invention in the FIG. 5. As shown in FIG. 6, first, in step 21, after at least one user 6 selects an icon 91 related to an application 81 in a browser picture 71, the service processing module 2 receives an icon selection message 41, and presents an advertisement link 73 related to the application 81 on a wall 72 on Facebook corresponding to the at least one user 6. The procedure goes to step 22.

In step 22, on the wall 72 on Facebook corresponding to the at least one user 6, after the advertisement link 73 related to the application 81 is selected, an advertisement link message 42 is transmitted to the service processing module 2. The procedure goes to step 23.

In step 23, after receiving the advertisement link message 42, the service processing module 2 enables the browser picture corresponding to the at least one user 6 returns to the browser picture 71 having the application 81 is returned.

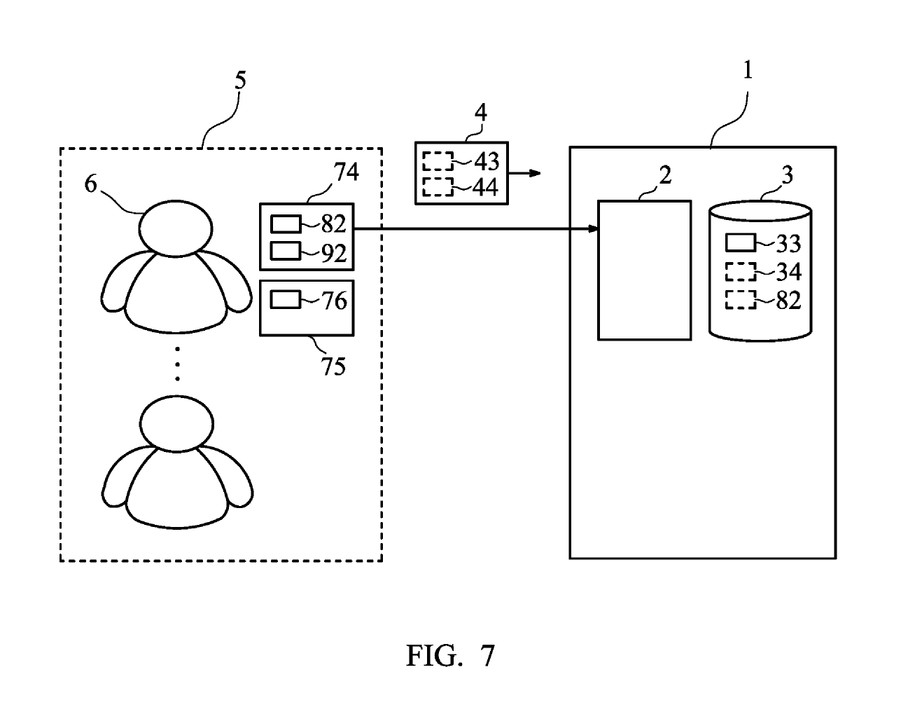

FIG. 7 is a system schematic diagram illustrating another embodiment and operation situations of the service system of the present invention. As shown in FIG. 7, the service system 1 comprises a service processing module 2, and an application database 3. Here, the personal webpage on a social website corresponding to the user 6 is Facebook, for example.

The service processing module 2 receives a use message 4 of a browse picture 74 corresponding to at least one user 6 on a network user side 5. Here, the use message 4 can comprise an icon selection message 43 and/or an exchange message 44.

Here, the icon selection message 43 is a message transmitted by the browse picture 74 after at least one user 6 selects an icon 92 related to an application 82 in the browse picture 74. The service processing module 2 receives and processes the icon selection message 43, and presents an advertisement link 76 related to the application 82 on a wall 75 on Facebook corresponding to the at least one user 6. Additionally, after receiving the icon selection message 43, the service processing module 2 operates in coordination with the application database 3 to record a number of selection times of the icon in the browser picture 74 for each user 6, and transforms the number of selection times (not shown) of the icon for each user into reward points 33, and stores the number of selection times of the icon and the reward points 33 for each user 6 in the application database 3.

The exchange message 44 is a message transmitted by the browser picture 74 when the respective user 6 exchanges the redeem applications 82 provided by the application developer (not shown). Here, the application database 3 has recorded the reward points 33 transformed from the number of selection times of the icon for each user 6. After the exchange message 44 is received, the service processing module 2 operates in coordination with the application database 3 to let the user 6 to exchange the redeem applications 82 provided by the application developer according to the reward points 33 transformed from the number of selection times of the icon for the user 6. The service processing module 2 provides the exchanged applications 82 to the user 6.

The application database 3 records the reward points 33 transformed from the number of selection times of the icon for respective users 6, and/or the applications 82 and applications 34 provided by the application developer. Here, the applications 34 can be obtained by exchanging the reward points transformed from the number of selection times of the icon, and/or with a free acquiring manner and/or a price reduction promotion manner.

In the embodiment, although the personal webpage on the social website corresponding to the user 6 is Facebook, however, for other personal webpage on the social websites, such as Weibo, QQ, Twitter, and others, the implementation situations and principle are similar to that of the present embodiments, and are omitted.

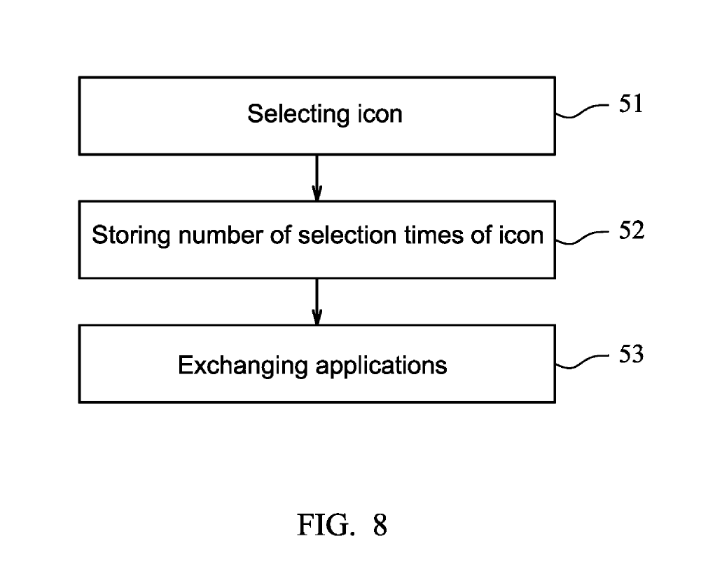

FIG. 8 is a flowchart of procedure steps of a service method performed by the embodiment of the service system of the present invention in the FIG. 7. As shown in FIG. 8, first, in step 51, after at least one user 6 selects an icon 92 related to an application 82 in a browser picture 74, the service processing module 2 receives an icon selection message 43, and presents an advertisement link 76 related to the application 82 on a wall 75 on Facebook corresponding to the at least one user 6. The procedure goes to step 52.

In step 52, after the icon selection message 43 is received, the service processing module 2 operates in coordination with the application database 3 to record a number of selection times of the icon in the browser picture 74 for each user 6, and transforms the number of selection times of the icon for each user 6 into reward points 33, and stores the number of selection times of the icon and the reward points 33 for each user 6 in the application database 3. The procedure goes to step 53.

In step 53, the user 6 can exchange the redeem applications 82 provided by the application developer. After the exchange message 44 from the user 6 is received, the service processing module 2 operates in coordination with the application database 3 to let the user 6 to exchange the redeem applications 82 provided by the application developer according to the reward points 33 transformed from the number of selection times of the icon for the user 6. The service processing module 2 provides the exchanged applications 82 to the user 6.

By synthesizing the above embodiments, service systems and methods to be used in an application download use environment are obtained, wherein after at least one user selects an icon related to an application in a browser picture, an advertisement link related to the application is presented on a wall of a personal webpage on a social website corresponding to the at least one user. After the advertisement link is selected, the browser picture having the application is returned. And/or, a number of selection times of the icon in the browser picture for each user is recorded, and the number of selection times of the icon for each user is transformed into reward points. The user can exchange the accumulated reward points for redeem applications provided by an application developer. In the method that the application developer allows users to exchange reward points for applications, the user browse popularity of the application in the browser picture can be quantized into reward points, and provided to the application developer for subsequent development reference. Here, the application developer can set an acquiring manner for the application in the browser picture, wherein the acquiring manner may be a manner where the application is exchanged by using the reward points quantized from the number of selection times of the icon, and/or a free acquiring manner and/or a price reduction promotion manner. The service systems and methods of the present invention have following advantages:

1. After at least one user selects an icon related to an application in a browser picture, an advertisement link related to the application is presented on a wall of a personal webpage on a social website (for example, Facebook, Weibo, QQ, Twitter, and others) corresponding to the at least one user. After the advertisement link is selected, the browser picture having the application is returned.

2. After the user selects an icon related to an application in a browser picture, a number of selection times of the icon in the browser picture for each user is recorded, and the number of selection times of the icon for each user is transformed into reward points. The user can exchange the accumulated reward points for redeem applications provided by an application developer. In the method that the application developer allows users to exchange reward points for applications, the user browse popularity of the application in the browser picture can be quantized into reward points, and provided to the application developer for subsequent development reference.

3. The application developer can set an acquiring manner for the application in the browser picture, wherein the acquiring manner may be a manner where the application is exchanged by using the reward points quantized from the number of selection times of the icon, and/or a free acquiring manner and/or a price reduction promotion manner.

Service methods, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. When implemented on a general-purpose processor, the program code combines with the processor to provide a unique apparatus that operates analogously to the application of specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A service method for use in an application download use environment, comprising:
after an icon related to an application in a browser picture is selected by at least one user, transmitting an icon selection message, and presenting an advertisement link related to the application on a wall of a personal webpage on a social website corresponding to the at least one user; and
processing the received icon selection message.

2. The method of claim 1, wherein the procedure for processing the received icon selection message comprises the steps of:
after the advertisement link related to the application on the wall of the personal webpage on the social website corresponding to the at least one user is selected, transmitting an advertisement message; and
after receiving the advertisement message, returning the browser picture of the at least on user to the browser picture having the application.

3. The method of claim 1, wherein the procedure for processing the received icon selection message comprises the steps of:
after receiving the icon selection message, recording a number of selection times of the icon in the browser picture for each user, and transforming the number of selection times of the icon for each user into reward points, and storing them respectively; and
exchanging the accumulated reward points for redeem applications provided by an application developer by the respective user.

4. The method of claim 1, wherein the procedure for processing the received icon selection message comprises the steps of:
after receiving the icon selection message, recording a number of selection times of the icon in the browser picture for each user, and transforming the number of selection times of the icon for each user into reward points, and storing them respectively; and
after receiving an exchange message from the user, letting the user to exchange the accumulated reward points for redeem applications provided by an application developer, and providing the exchanged application to the user.

5. A service method for use in an application download use environment, comprising:
after at least one user selects an icon related to an application in a browser picture, transmitting an icon selection message, and presenting an advertisement link related to the application on a wall of a personal webpage on a social website corresponding to the at least one user; and
after the advertisement link is selected, returning to the browser picture having the application; and/or
after the icon is selected, recording a number of selection times of the icon in the browser picture for each user, and transforming the number of selection times of the icon for each user into reward points, and letting the user to exchange the accumulated reward points for redeem applications provided by an application developer.

6. A service system for use in an application download use environment, comprising:
a service processing module, wherein after an icon related to an application in a browser picture is selected by at least one user, an icon selection message is transmitted, the service processing module receives the icon selection message, and presents an advertisement link related to the application on a wall of a personal webpage on a social website corresponding to the at least one user, and the service processing module processes the received icon selection message; and
an application database, wherein after the service processing module received the icon selection message, the service processing module operates in coordination with the application database to record a number of selection times of the icon in the browser picture for each user, and transforms the number of selection times of the icon for each user into reward points, and stores the number of selection times of the icon and the reward points for each user in the application database.

7. The system of claim 6, wherein after the advertisement link related to the application on the wall of the personal webpage on the social website corresponding to the at least one user is selected, an advertisement message is transmitted to the service processing module, and after receiving the advertisement message, the service processing module returns the browser picture of the at least on user to the browser picture having the application.

8. The system of claim 6, wherein after receiving an exchange message from the user, the service processing module provides redeem applications provided by an application developer to the user.

9. The system of claim 6, wherein after receiving an exchange message from the user, the service processing module operates in coordination with the application database to let the user to exchange the accumulated reward points for redeem applications provided by an application developer, and provides the exchanged application to the user.

10. A service system for use in an application download use environment, comprising:
a service processing module, wherein after an icon related to an application in a browser picture is selected by at least one user, an icon selection message is transmitted, the service processing module receives the icon selection message, and presents an advertisement link related to the application on a wall of a personal webpage on a social website corresponding to the at least one user, and the service processing module processes the received icon selection message, after the advertisement link related to the application on the wall of the personal webpage on the social website corresponding to the at least one user is selected, an advertisement message is transmitted to the service processing module, and after receiving the advertisement message, the service processing module returns the browser picture of the at least on user to the browser picture having the application, and/or after receiving an exchange message from the user, the service processing module operates in coordination with the application database to let the user to exchange the accumulated reward points for redeem applications provided by an application developer, and provides the exchanged application to the user; and
an application database, wherein after the service processing module received the icon selection message, the service processing module operates in coordination with the application database to record a number of selection times of the icon in the browser picture for each user, and transforms the number of selection times of the icon for each user into reward points, and stores the number of selection times of the icon and the reward points for each user in the application database.
